(19) United States
(12) Patent Application Publication
(10) Pub. No.: US 2014/0140920 A1
(43) Pub. Date: May 22, 2014

(54) VANADIUM-BASED HYDROGEN PERMEATION ALLOY FOR MEMBRANE, METHOD OF MANUFACTURING THE SAME, AND METHOD OF USING THE MEMBRANE

(71) Applicant: KOREA INSTITUTE OF SCIENCE AND TECHNOLOGY, Seoul (KR)

(72) Inventors: Jin-Yoo SUH, Seoul (KR); Ja-ryeong KIM, Seoul (KR); Eric FLEURY, Seoul (KR); Young-Su LEE, Seoul (KR); In-Suk CHOI, Seoul (KR); Young-Whan CHO, Seoul (KR); Dong-Ik KIM, Seoul (KR); Jae-Hyeok SHIM, Seoul (KR)

(73) Assignee: KOREA INSTITUTE OF SCIENCE AND TECHNOLOGY, Seoul (KR)

(21) Appl. No.: 14/084,219

(22) Filed: Nov. 19, 2013

(30) Foreign Application Priority Data
Nov. 19, 2012 (KR) 10-2012-0130973

(51) Int. Cl. C22C 27/02; C01B 3/50

(52) U.S. Cl. CPC C22C 27/025; C01B 3/508
USPC 423/648.1; 420/424; 164/76.1; 164/69.1

(57) ABSTRACT

A vanadium-based hydrogen permeation alloy for a membrane, a method of manufacturing the same, and a method of using a membrane including the same are provided. The vanadium-based hydrogen permeation alloy for a membrane includes nickel (Ni) at more than 0 atm % and 5 atm % or less, iron (Fe) at 5 atm % to 15 atm %, yttrium (Y) at more than 0 atm % and 1 atm % or less, and a remainder of vanadium and impurities.

### CROSS-REFERENCE TO RELATED APPLICATION

This application claims priority to and the benefit of Korean Patent Application No. 10-2012-0130973 filed in the Korean Intellectual Property Office on Nov. 19, 2012, the entire contents of which are incorporated herein by reference.

### BACKGROUND OF THE INVENTION

(a) Field of the Invention

The present invention relates to a vanadium-based hydrogen permeation alloy for a membrane, a method of manufacturing the same, and a method of using the membrane. More particularly, the present invention relates to a vanadium-based hydrogen permeation alloy that is used for a membrane, a method of manufacturing the same, and a method of using the membrane

(b) Description of the Related Art

Hydrogen is variously used in industrial fields, and currently, according to technology development of a fuel cell, technology that obtains high purity hydrogen gas is important. Hydrogen can be produced in a large quantity using various methods, and hydrogen may be separated and used using a membrane that can be made of various different materials.

A metal-based hydrogen membrane may be used to separate and use hydrogen. A metal-based hydrogen membrane separates and refines hydrogen by selectively permeating only hydrogen from a gas containing hydrogen in a temperature range of about 200° C. to 600° C. When hydrogen passes through a metal membrane, hydrogen does not exist in a diatomic molecule state of H₂, which is a general form, but diffuses and penetrates spaces through metal lattices in a dissociated atomic hydrogen state. Due to the penetration phenomenon of the atomic hydrogen significantly faster than other impurity atoms in solids, the metal membrane has a different separation mechanism from that of a membrane that is formed with a polymer in which a hydrogen molecule (H₂) directly passes through empty space or a membrane that is formed with a porous ceramic, and a probability in which other gases pass through together with hydrogen is extremely low.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vanadium-based hydrogen permeation alloy for a membrane having high hydrogen transmittance while having excellent resistance to hydrogen embrittlement. The present invention has been made in an effort to further provide a method of manufacturing the vanadium-based hydrogen permeation alloy for a membrane. The present invention has been made in an effort to further provide a method of using a membrane that is formed with the vanadium-based hydrogen permeation alloy.

An exemplary embodiment of the present invention provides a vanadium-based hydrogen permeation alloy for a membrane including nickel (Ni) at more than 0 atm % and 5 atm % or less, iron (Fe) at 5 atm % to 15 atm %, yttrium (Y) at more than 0 atm % and 1 atm % or less, and a remainder of vanadium and impurities.

A quantity of the nickel (Ni) may be 3 atm % to 5 atm %, a quantity of the iron (Fe) may be 8 atm % to 15 at %, and a quantity of the yttrium (Y) may be more than 0 atm % and 0.2 atm % or less. A quantity of the iron (Fe) may be 8 atm % to 12 atm %, and a quantity of the yttrium (Y) may be 0.1 atm % to 0.2 atm %.

Another embodiment of the present invention provides a method of manufacturing a vanadium-based hydrogen permeation alloy for a membrane, the method including: i) providing a mixture by mutually mixing nickel, iron, yttrium, and a remainder of vanadium and impurities; ii) providing an alloy by melting the mixture; and iii) providing a thin film by cutting or rolling the alloy. In the providing of a mixture, a quantity of the nickel (Ni) is more than 0 atm % and 5 atm % or less, a quantity of the iron (Fe) is 5 atm % to 15 atm %, and a quantity of the yttrium (Y) is more than 0 atm % and 1 atm % or less.

Yet another embodiment of the present invention provides a method of using a vanadium-based hydrogen permeation alloy, including: i) providing a membrane including a vanadium-based hydrogen permeation alloy including nickel (Ni) at more than 0 atm % and 5 atm % or less, iron (Fe) at 5 atm % to 15 atm %, yttrium (Y) at more than 0 atm % and 1 atm % or less, and a remainder of vanadium and impurities; and ii) permeating hydrogen by operating the membrane at a temperature of 250° C. to 500° C.

Because a vanadium-based alloy in which nickel and iron are mixed with vanadium is used, resistance to hydrogen embrittlement of a hydrogen permeability membrane can be improved. Further, because the vanadium-based alloy contains yttrium, interface stability of a hydrogen permeable membrane and a palladium catalyst layer can be enhanced. Therefore, a vanadium-based hydrogen permeation alloy for a membrane having excellent resistance to hydrogen embrittlement and excellent hydrogen permeation performance can be produced. Further, by alloying iron or nickel together with vanadium, while maintaining the diffusion coefficient of hydrogen in the alloy equal to that in pure vanadium, only solubility of hydrogen can be selectively deteriorated. Therefore, by reducing the lattice expansion caused by hydrogen absorption, the tendency for hydrogen embrittlement while not greatly reducing a flux of hydrogen can be minimized.

### BRIEF DESCRIPTION OF THE DRAWINGS

FIG. 1 is a flowchart illustrating a method of manufacturing a vanadium-based hydrogen permeation alloy for a membrane according to an exemplary embodiment of the present invention.

FIG. 2 is a binary phase diagram of vanadium and nickel.

FIG. 3 is a binary phase diagram of vanadium and iron.

FIG. 4 is a graph illustrating hydrogen permeability of a membrane that is formed with a V—Fe alloy according to Experimental Examples 1 to 5.

FIGS. 5 and 6 are graphs illustrating a change of hydrogen permeability according to a temperature of a membrane of Experimental Example 3 and Comparative Example 1, respectively.

FIGS. 7 to 9 are graphs illustrating diffusion coefficients, permeability, and solubility of hydrogen in membranes that are produced according to Experimental Examples 1 and 3, respectively.

FIGS. 10 and 11 are transmission electron microphotographs of a section of membrane surfaces of Experimental Example 6 and Comparative Example 2, respectively.

FIG. 12 is a hydrogen permeability experiment graph of a hydrogen permeation alloy of Experimental Example 7 of the present invention.

FIG. 13 is an on-off type hydrogen permeability experiment graph of a hydrogen permeation alloy of Experimental Example 7 of the present invention.

### DETAILED DESCRIPTION OF THE EMBODIMENTS

When it is said that any part is positioned “on” another part, it means the part is directly on the other part or above the other part with at least one intermediate part. In contrast, if any part is said to be positioned “directly on” another part, it means that there is no intermediate part between the two parts.

Terms such as first, second, and third are used for describing various portions, components, areas, layers, and/or sections, but the terms are not limited thereto. The terms are used only for distinguishing any portion, component, area, layer, or section from other portions, components, areas, layers, or sections. Therefore, a first portion, component, area, layer, or section described hereinafter may be described as a second portion, component, area, layer, or section without deviating from the scope of the present invention.

Technical terms used here are to only describe a specific exemplary embodiment and are not intended to limit the present invention. Singular forms used herein include multiple forms unless phrases explicitly represent an opposite meaning. A meaning of “comprising” or “including” used in the specification and claims embodies a specific characteristic, area, integer, step, operation, element, and/or component, and does not exclude presence or addition of another characteristic, area, integer, step, operation, element, and/or component.

Unless differently defined, all terms including technical terms and scientific terms used herein have the same meaning as one that may be generally understood by a person of common skill in the art. Further, terms defined in a generally-used dictionary have a meaning corresponding to related technology documents and presently disclosed contents, and are not analyzed as an ideal or overly official meaning unless stated otherwise.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

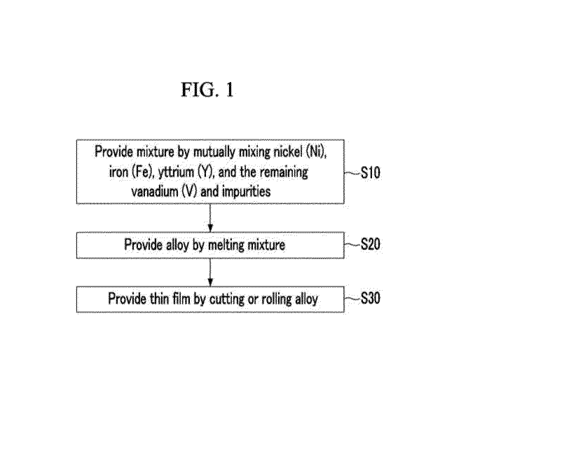

FIG. 1 is a flowchart illustrating a method of manufacturing a vanadium-based hydrogen permeation alloy for a membrane according to an exemplary embodiment of the present invention. The method of manufacturing a vanadium-based hydrogen permeation alloy for a membrane of FIG. 1 illustrates the present invention, and the present invention is not limited thereto. Therefore, the method of manufacturing a vanadium-based hydrogen permeation alloy for a membrane may be changed in different forms.

As shown in FIG. 1, the method of manufacturing a vanadium-based hydrogen permeation alloy for a membrane includes: i) providing a mixture by mutually mixing nickel, iron, yttrium, and a remainder of vanadium and impurities (S10); ii) providing an alloy by melting the mixture (S20); and iii) providing a thin film by cutting or rolling the alloy (S30). In addition, the method of manufacturing a vanadium-based hydrogen permeation alloy for a membrane may further include other steps.

First, by mutually mixing nickel (Ni), iron (Fe), yttrium (Y), and a remainder of vanadium (V) and impurities, a mixture is provided (S10). Other elements may be further mixed therein, as needed.

Nickel (Ni) improves resistance to hydrogen embrittlement of a hydrogen permeation alloy. That is, nickel can suppress the formation of hydride that causes hydrogen embrittlement, and when a nickel-containing vanadium alloy is exposed to hydrogen pressure, the nickel forms solid solution into a lattice to reduce a quantity of permeating hydrogen atoms. Nickel suppresses the hydride formation that causes hydrogen embrittlement. Further, when nickel is exposed to the same external hydrogen pressure, nickel reduces a quantity of hydrogen atoms entering into a lattice, and thus lattice expansion is reduced. A quantity of nickel may be more than 0 and 5 atm % or less. When the quantity of nickel is excessive, an intermetallic compound of vanadium-nickel is generated. Then, when hydrogen is absorbed, a crack generation probability increases at an interface of a second phase and a host phase. Therefore, the quantity of nickel is adjusted to the foregoing range. More preferably, the quantity of nickel may be adjusted to 3 atm % to 5 atm %.

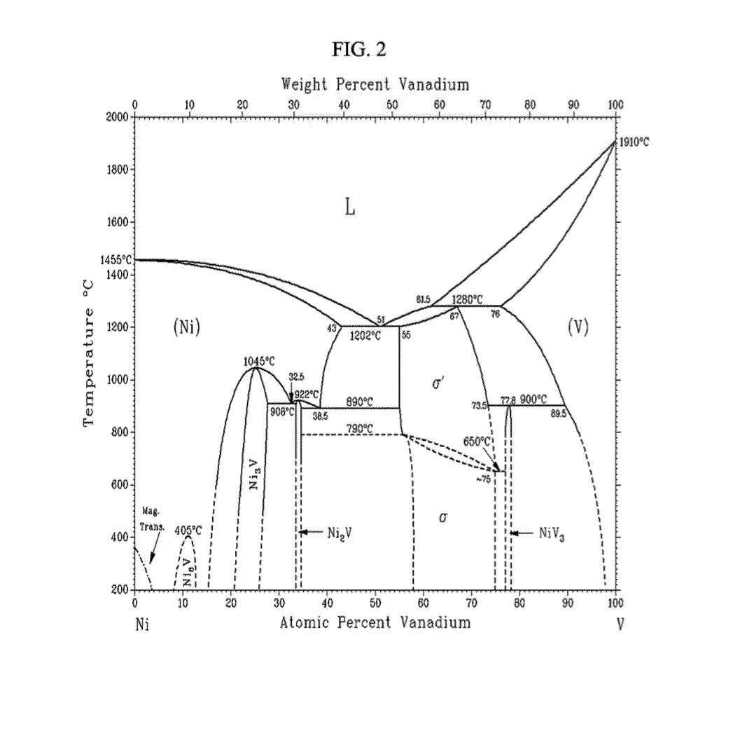

FIG. 2 is a binary phase diagram of vanadium and nickel. As shown in FIG. 2, when nickel is added to vanadium, even in a case in which the quantity of nickel is 10 atm %, nickel does not exist in a solid solution state that is completely solutionized in vanadium, and a second phase may be generated with an intermetallic compound of NiV₃ containing a large amount of nickel. When solidifying and immediately cooling an alloy containing nickel at, for example, 15 atm % or when performing solution processing and cooling an alloy containing nickel at, for example, 15 atm % at a high temperature of about 1300° C., a second phase is not formed. However, after heat treatment is performed at a temperature of about 1000° C., when the alloy is cooled, a second phase is formed. Further, when the hydrogen permeation alloy is exposed in a hydrogen atmosphere at about 400° C., a thermodynamically stable second phase may be generated. When a second phase is formed, a metal lattice that is exposed to hydrogen may become unstable. For example, hydrogen atoms may be trapped between an interface of the second phase and the host phase, and a stress is concentrated on the interface and thus the interface may become an initiation point of a hydrogen embrittlement fracture.

Iron (Fe) of step S10 of FIG. 1 has a body-centered cubic lattice structure at room temperature such as vanadium, niobium, or tantalum. Further, a hydrogen diffusion coefficient of iron is larger than that of vanadium. However, because solubility of hydrogen is small in an iron lattice, a flux of hydrogen that passes through the iron lattice is lower than that of vanadium. Likewise, when iron is actually added to vanadium, hydrogen solubility of a hydrogen permeation alloy is deteriorated more than a diffusion coefficient of the hydrogen permeation alloy. Because hydrogen solubility of vanadium efficiently decreases due to iron, resistance to hydrogen embrittlement of a hydrogen permeation alloy is improved. Here, the quantity of iron that is added to the hydrogen permeation alloy may be 5 atm % to 15 atm %. When the quantity of iron is too small, the hydrogen embrittlement of the hydrogen permeation alloy may occur. Further, when the quantity of iron is too large, an intermetallic compound of vanadium-iron is generated and its interface with surrounding matrix is likely to be the initiation point of hydrogen-induced failure. Accordingly, the quantity of iron is adjusted to the foregoing range. More preferably, the quantity of iron may be adjusted to 8 atm % to 15 atm %. Further preferably, the quantity of iron may be adjusted to 8 atm % to 12 atm %.

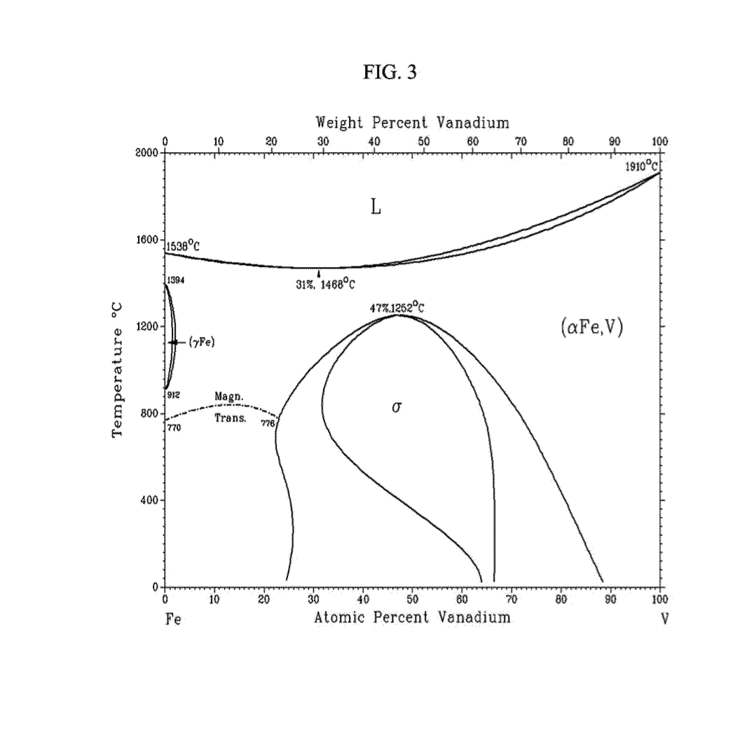

FIG. 3 is a binary phase diagram of vanadium and iron.

Iron in vanadium forms solid solution up to 11 atm % addition as can be confirmed by the binary V—Fe phase diagram shown in FIG. 3. Accordingly, iron has a greater advantage than nickel. At about 400° C. which is appropriate for hydrogen permeation, vanadium-iron binary alloy can form complete solid solution with iron content up to 18 atm %. Therefore, in an exemplary embodiment of the present invention, by alloying iron to a hydrogen permeation alloy, the resistance to hydrogen embrittlement of the hydrogen permeation alloy can be improved.

When a hydrogen pressure exists, upon cooling, the hydrogen permeation alloy may be broken at a low temperature. This is due to the negative heat of hydrogen absorption of vanadium alloys; hydrogen is more stable when it is inside vanadium lattice than in the air forming hydrogen molecule. Due to a characteristic of such vanadium, while the temperature drops, a quantity of hydrogen existing within a hydrogen permeation alloy increases. Therefore, while the temperature is lowered, the lattice expansion level caused by hydrogen absorption is further deepened. In addition, at a low temperature of about 200° C. or less, vanadium hydride is generated to operate as a start point of a fracture.

Yttrium (Y) of step S10 of FIG. 1 minimizes mutual diffusion between a palladium catalyst coating layer of a membrane and a membrane base metal. Therefore, by stabilizing the catalyst layer on a membrane surface, a reaction speed of dissociation and recombination of a hydrogen molecule may be maintained at its best condition by the addition of Y.

Yttrium (Y) removes oxygen impurities of a very small amount existing inside vanadium lattices. Because oxygen positions itself at an octahedral site between vanadium atoms, the oxygen generally elastically interacts with hydrogen that diffuses through a tetrahedral site and inhibits hydrogen from moving. In other words, the oxygen impurity can work as a hydrogen-trapping site. And, such a hydrogen-trapping site generally affects (deteriorates) the hydrogen diffusion in the temperature lower than 400° C. Therefore, by removing oxygen within a lattice by adding yttrium, hydrogen diffusion can be enhanced. In addition, yttrium can improve durability and high temperature stability of a palladium coating layer of a membrane surface. A quantity of yttrium may be more than 0 atm % and 1 atm % or less. When the quantity of yttrium is too much, yttrium is generally positioned at a grain boundary and hot workability of a material is deteriorated. Therefore, the quantity of yttrium is adjusted to the foregoing range. More preferably, the quantity of yttrium may be adjusted to 0.2 atm % or less. Further preferably, the quantity of yttrium may be adjusted to 0.1 atm % to 0.2 atm %.

Vanadium (V) of step S10 of FIG. 1 is used as a main raw material of a hydrogen permeation alloy. Vanadium has very high hydrogen permeability together with other BCC metals, i.e., niobium and tantalum, in the fifth column in the periodic table. However, because such metal elements incur hydrogen embrittlement, in an exemplary embodiment of the present invention, resistance to hydrogen embrittlement is improved through appropriate alloying.

The melting point of vanadium is 1910° C., which is much lower than that of niobium (2477° C.) and tantalum (3017° C.). Therefore, an alloy may be more easily produced using vanadium, compared with niobium or tantalum. Further, vanadium has a high hydrogen diffusion coefficient, compared with niobium or tantalum. Hydrogen permeability of niobium is larger than that of vanadium, but a diffusion coefficient thereof is smaller than that of vanadium and thus a quantity of hydrogen entering into a niobium lattice is much greater. Therefore, hydrogen embrittlement resistance of a niobium-based membrane is lower than that of a vanadium-based membrane. Vanadium is thus more appropriate than niobium or tantalum as a material of a membrane.

Next, by melting a mixture, an alloy may be provided (S20). For example, by arc melting or by vacuum induced melting a mixture at a high temperature, an alloy in which metals are mutually uniformly mixed may be produced.

Finally, by cutting or rolling the alloy, a thin film may be provided (S30). Here, the thickness of the thin film may range from 30 μm to 500 μm. When the thickness of the thin film is too small or too large, it is inappropriate to use the thin film as a membrane. Therefore, a thickness of the thin film is adjusted to the foregoing range. In order to manufacture a thin film, by electro-discharge cutting an alloy, the thin film may be sliced into a thin plate. Further, by discharge processing a melted ingot and by slicing and cold rolling the ingot into a thin plate or a somewhat thick plate, the thickness of the plate is adjusted, and by a post-heating treatment, the plate may be recrystallized. Alternatively, by hot rolling the melted ingot, the ingot is produced into a somewhat thick plate, and by cold rolling the plate, the plate may be transformed into a thin plate.

At a surface of a membrane that is produced with the foregoing method, palladium (Pd) may be coated at a thickness of about 100 nm. A palladium (Pd) coating layer dissociates hydrogen molecules into hydrogen atoms and recombines the hydrogen atoms to the hydrogen molecules. A membrane that is produced by the foregoing method has excellent hydrogen permeation characteristics and is structurally stable. Therefore, the palladium (Pd) coating layer may replace expensive palladium that is used as a main material of a hydrogen permeation alloy. A hydrogen permeation alloy that is produced through the foregoing method may be used at a temperature between 250° C. and 500° C. When the operation temperature of the hydrogen permeation alloy is less than 250° C., the temperature is too low and thus the hydrogen permeation alloy is inappropriate to hydrogen permeability. Further, when the operation temperature of the hydrogen permeation alloy exceeds 500° C., mutual diffusion between the palladium catalyst layer that is coated at a surface and a vanadium-based hydrogen permeation alloy is activated, and thus the catalyst layer of the surface may be easily damaged.

As a generally known membrane, palladium-based alloys such as palladium (Pd), palladium-silver (Pd—Ag), and palladium-copper (Pd—Cu) are used. However, because of a lack of palladium deposits worldwide, in order to prepare for a resource shortage that may occur when the demand for hydrogen separation rapidly increases with the arrival of a hydrogen energy society, metals of a body-centered cubic structure of vanadium (V), niobium (Nb), and tantalum (Ta) in the fifth column of the periodic table are considered as viable replacement materials for palladium.

Vanadium, niobium, and tantalum have a high hydrogen permeability flux of about 10 times to 100 times that of palladium, but due to serious hydrogen embrittlement of a membrane, the membrane is likely to break during a hydrogen permeation operation. Therefore, by adding various alloy elements, a quantity of hydrogen that permeates through a lattice together with the probability of hydrogen embrittlement is reduced. But it is still difficult to manufacture a membrane having the same level of hydrogen permeation performance and structural stability as palladium (Pd). Further, vanadium (V), niobium (Nb), and tantalum (Ta) are remarkably lower in catalyst performance for dissociating hydrogen molecules to hydrogen atoms or recombining monatomic hydrogen to hydrogen molecules than palladium (Pd). In order to overcome this, by coating palladium (Pd) on both surfaces of a membrane, both surfaces are used as catalyst layers. However, it is difficult to avoid a phenomenon of formation of a reaction layer or mutual diffusion between the catalyst layer and a membrane base metal in view of a characteristic of a metal-based membrane that is used at a high temperature.

In contrast, in an exemplary embodiment of the present invention, by using a vanadium-based alloy including iron, yttrium, and nickel, while preventing hydrogen embrittlement of a membrane, the hydrogen permeability performance can be enhanced.

Hereinafter, the present invention will be described in detail through experimental examples. Such experimental examples illustrate the present invention, and the present invention is not limited thereto.

### EXPERIMENTAL EXAMPLES

### Effect Experiment of Membrane formed with Vanadium-based Alloy According to Addition of Iron

Experimental Example 1

A characteristic of a vanadium-based alloy membrane according to addition of iron was evaluated. For this purpose, a membrane that is formed with a V—Fe alloy which is a binary system was prepared, and for the membrane, basic properties related to hydrogen were evaluated. For this purpose, a vanadium-based alloy containing Fe at 10 atm % was prepared as a V—Fe alloy. At a temperature of 300° C. to 400° C., hydrogen permeability of a membrane that is formed with a V—Fe alloy which is a binary system was measured.

Experimental Example 2

A vanadium-based alloy containing Fe at 12.5 atm % was prepared as a V—Fe alloy. The production process of the vanadium-based alloy was the same as that of Experimental Example 1.

Experimental Example 3

A vanadium-based alloy containing Fe at 15 atm % was prepared as a V—Fe alloy. The production process of the vanadium-based alloy was the same as that of Experimental Example 1.

Experimental Example 4

A vanadium-based alloy containing Fe at 20 atm % was prepared as a V—Fe alloy. The production process of the vanadium-based alloy was the same as that of Experimental Example 1.

Experimental Example 5

A vanadium-based alloy containing Fe at 25 atm % was prepared as a V—Fe alloy. The production process of the vanadium-based alloy was the same as that of Experimental Example 1.

Comparative Example 1

For comparison with the experimental examples, a membrane formed with pure vanadium was produced. The membrane was produced by discharge machining after vacuum arc melting a pure vanadium ingot. The hydrogen permeability flux according to a temperature change was measured using a membrane produced with pure vanadium, and upon cooling to a low temperature after a hydrogen permeability operation, a time point at which a brittle fracture occurred was measured.

### Experiment Results

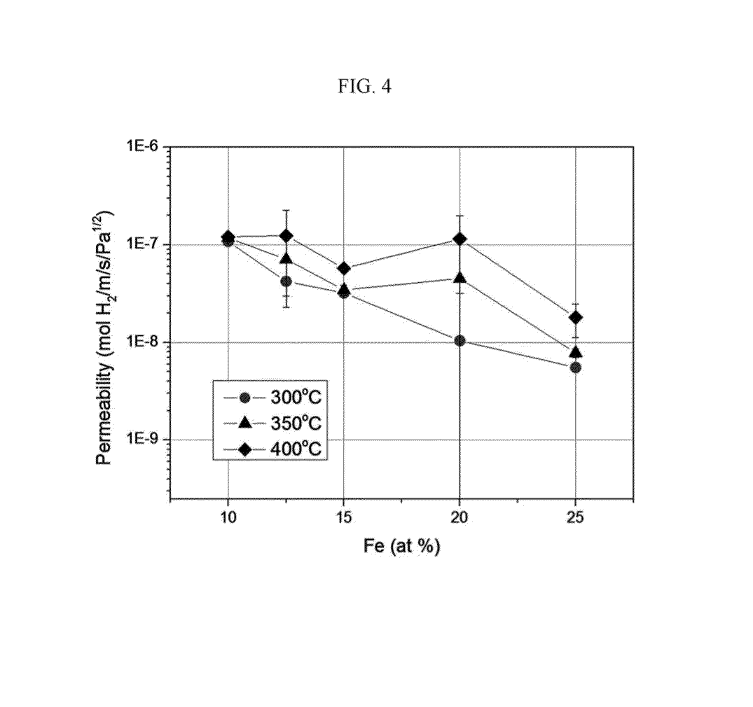

FIG. 4 illustrates hydrogen permeability of a membrane formed with V—Fe alloys according to Experimental Examples 1 to 5.

As shown in FIG. 4, as the content of iron that is contained in the membrane increased, a phenomenon in which hydrogen permeability decreased was clearly determined. Particularly, a membrane containing iron at 15 atm % or less of Experimental Examples 1 to 3 exhibited high hydrogen permeability of 3×10⁻⁸ (mol H₂/m/s/Pa^{1/2}) or more at a temperature of 300° C. or more. In contrast, a membrane formed with pure palladium exhibited hydrogen permeability of 8.4×10⁻⁹ (mol H₂/m/s/Pa^{1/2}) at 300° C., 1.1×10⁻⁸ (mol H₂/m/s/Pa^{1/2}) at 350° C., and 1.3×10⁻⁸ (mol H₂/m/s/Pa^{1/2}) at 400° C. Therefore, it can be seen that a membrane according to Experimental Examples 1 to 3 exhibited hydrogen permeability of at least 3 times that of a membrane formed with pure palladium at 300° C. to 400° C.

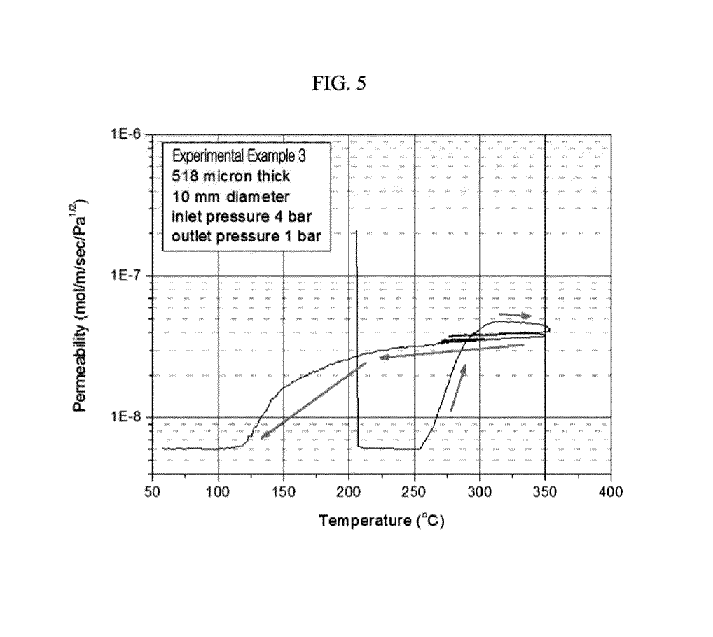

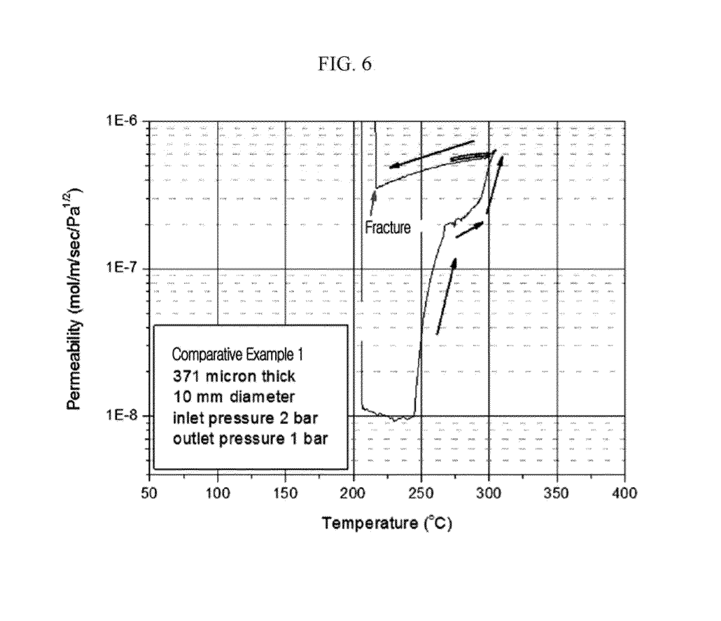

FIGS. 5 and 6 illustrate a change of hydrogen permeability according to temperature of membranes of Experimental Example 3 and Comparative Example 1. FIG. 5 represents a change of hydrogen permeability according to temperature of a membrane of Experimental Example 3 by an arrow, and FIG. 6 represents a change of hydrogen permeability according to temperature of a membrane of Comparative Example 1 by an arrow.

The thickness of the membrane used in Experimental Example 3 was 518 μm, and the diameter thereof was 10 mm. Further, the inlet pressure was 4 bar, and the output pressure was 1 bar. The thickness of the membrane used in Comparative Example 1 was 371 μm, and the diameter thereof was 10 mm. Further, the inlet pressure was 2 bar, and the output pressure was 1 bar.

In an initial stage, in a state in which the pressure was applied to a front end portion of a membrane, when the temperature rises and exceeds about 250° C., hydrogen started to permeate through the membrane. Through several temperature rise and drop cycles, it was determined that the hydrogen permeation operation was stably repeated.

After repeating the temperature cycle, in a state in which a pressure is applied to a front end portion of a membrane, when the temperature is cooled to room temperature, the membrane of Comparative Example 1 of FIG. 6 exhibited a phenomenon in which the hydrogen flux suddenly increased while the membrane broke at a temperature of about 210° C. In contrast, the membrane of Experimental Example 3 of FIG. 5 was cooled to room temperature without breaking. Therefore, when iron is added, it was determined that resistance to hydrogen embrittlement of a membrane may be improved.

In a membrane that is produced according to Experimental Examples 1 and 3, the diffusion coefficient, permeation, and solubility, which are basic properties of hydrogen, were measured with a gas permeation method.

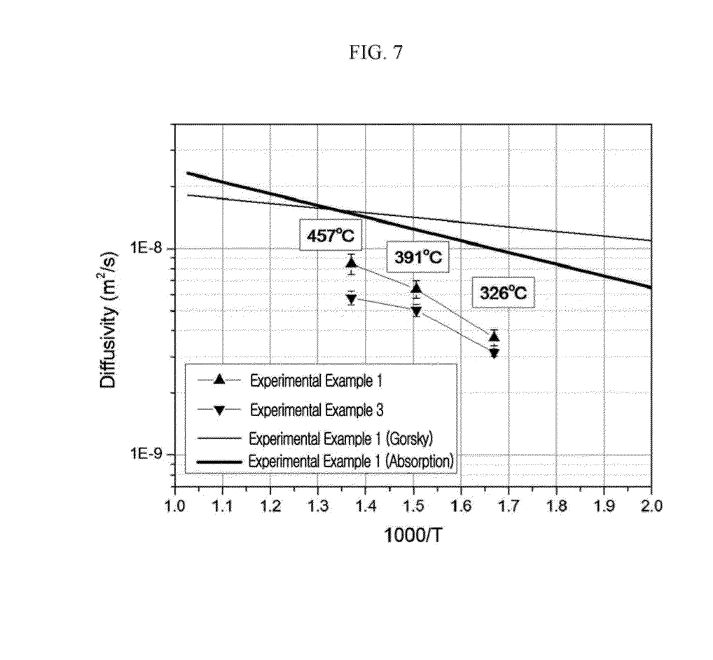

FIGS. 7 to 9 compare diffusion coefficients, permeability, and solubility of hydrogen in membranes of Experimental Examples 1 and 3 with those of hydrogen in a membrane of Comparative Example 1.

The membrane of Comparative Example 1 exhibited serious hydrogen embrittlement compared with the membranes of Experimental Examples 1 and 3. Therefore, it was difficult to measure the diffusion coefficient, permeation, and solubility, which are basic properties of hydrogen, with a gas permeation method.

In more detail, FIG. 7 represents a diffusion coefficient of hydrogen in the membranes of Experimental Examples 1 and 3. Diffusion coefficient values of pure vanadium of Comparative Example 1 of FIG. 7 are quoted from “The Metal-Hydrogen System” of Y. Fukai, a diffusion coefficient of hydrogen that is represented by “Gorsky” is obtained by measuring a membrane using a Gorsky method, and a diffusion coefficient of hydrogen that is represented with “Absorption” is obtained by measuring a membrane using absorption-desorption.

It was determined that by using a vanadium-based alloy to which iron is added in the membrane, diffusion coefficients of hydrogen in membranes of Experimental Examples 1 and 3 were reduced to about ½ or ⅓, compared with the diffusion coefficient of hydrogen in the membrane of Comparative Example 1. As the content of iron increased, it was determined that the diffusion coefficient of hydrogen was further lowered somewhat.

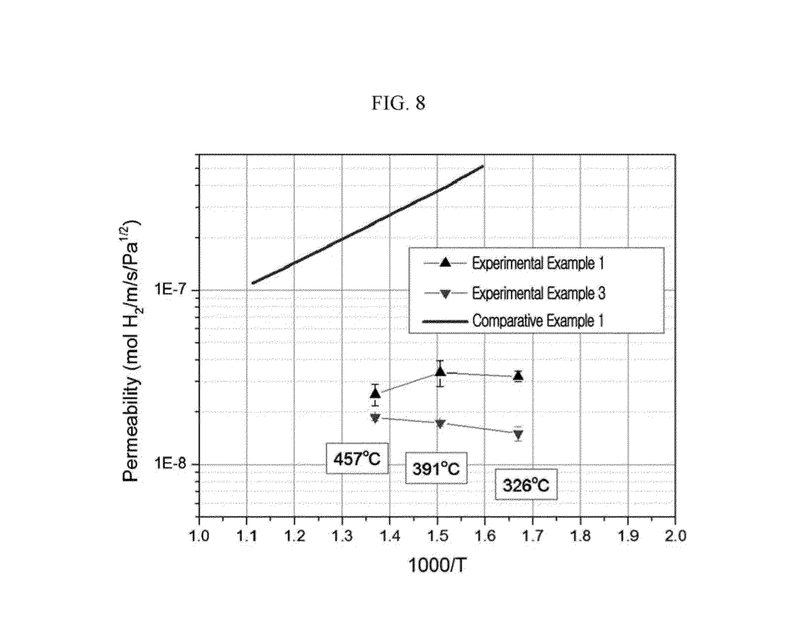

FIG. 8 illustrates hydrogen permeability in a membrane of Experimental Examples 1 and 3. Hydrogen permeability of a membrane that is formed with pure vanadium of Comparative Example 1 of FIG. 8 was described with reference to contents that are disclosed on the REB Research & Consulting website (http://www.rebresearch.com).

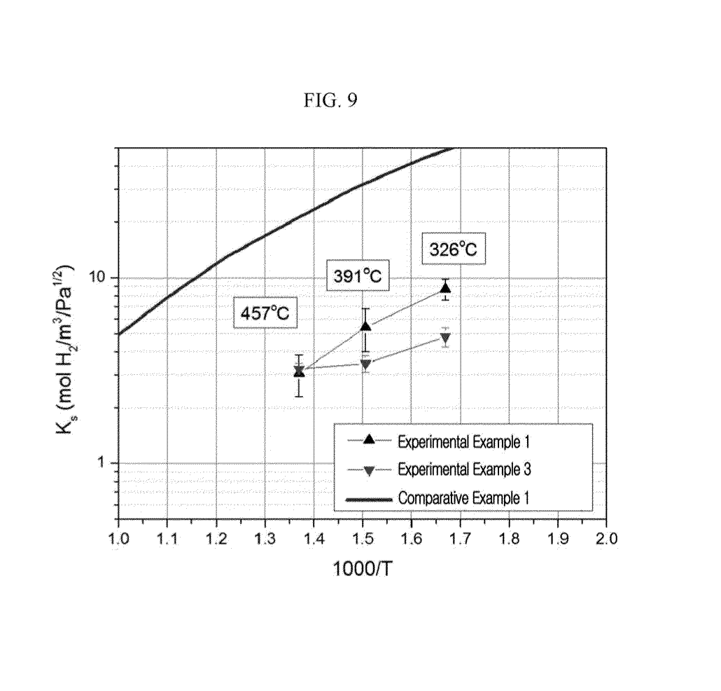

Permeability of hydrogen of FIG. 8 is represented as a product of a diffusion coefficient of FIG. 7 and solubility of FIG. 9. As shown in FIG. 8, it can be seen that hydrogen permeability is lowered to 1/10 according to the addition of iron.

FIG. 9 represents solubility of hydrogen in a membrane of Experimental Examples 1 and 3. A hydrogen solubility constant of a membrane that is formed with pure vanadium of Comparative Example 1 of FIG. 9 was described with reference to contents that are disclosed on the REB Research & Consulting website (http://www.rebresearch.com).

As shown in FIG. 9, it was determined that solubility of hydrogen in Experimental Examples 1 and 3 was reduced to about ⅕, compared with a membrane of Comparative Example 1 according to addition of iron. Therefore, it was determined that an effect of addition of iron operates much more in reduction of solubility of hydrogen than in reduction of a diffusion coefficient.

In the membrane of Experimental Example 3, low temperature fracture by hydrogen did not occur. That is, as iron was added to a hydrogen permeation alloy, the quantity of hydrogen that permeated into a vanadium lattice was effectively reduced. In Experimental Example 3, as iron was added, it was determined that vanadium hydride was suppressed from being generated.

### Effect Experiment of Membrane Formed with Vanadium-based Alloy according to Addition of Yttrium

Experimental Example 6

A characteristic of a vanadium-based alloy membrane according to addition of yttrium to a V—Ni alloy membrane, which is a binary system, was evaluated. For this purpose, a membrane formed with a V—Ni—Y alloy which is a ternary system was prepared, and for the membrane, basic properties that are related to hydrogen were evaluated. For this purpose, by adding Y at 0.2 atm % to a V₉₀N₁₀ alloy, a vanadium-based alloy of a V_{89.8}Ni₁₀Y_{0.2} composition was prepared.

Comparative Example 2

For comparison with the experimental examples, a membrane formed with an alloy of a V₉₀Ni₁₀ composition was produced. The membrane was produced using a generally known method.

Experiment Result

A section structure of a membrane surface of Experimental Example 6 was observed using a transmission electron microscope. After a hydrogen permeability experiment of a membrane was performed for a long time at a temperature of 400° C., the membrane was observed with the transmission electron microscope.

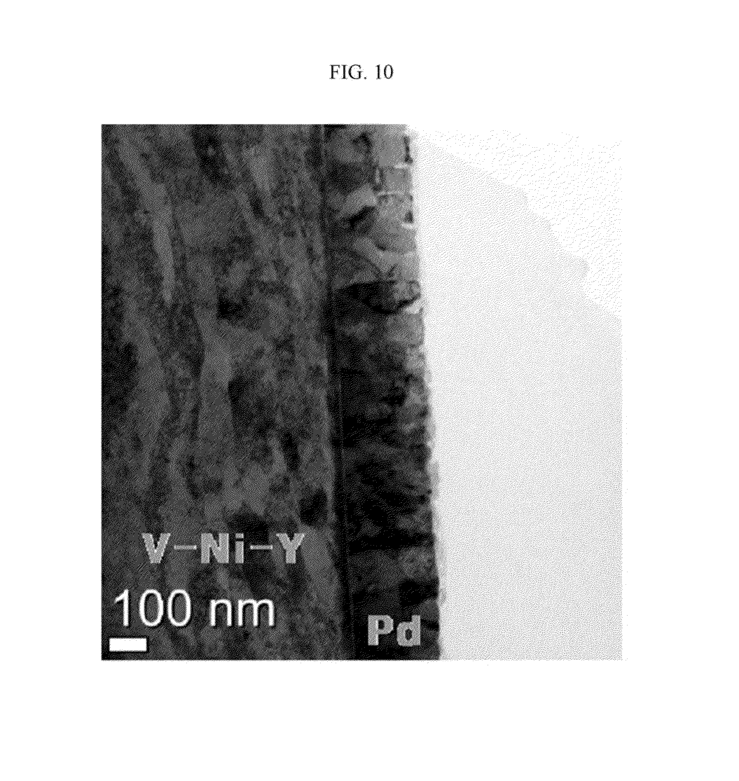

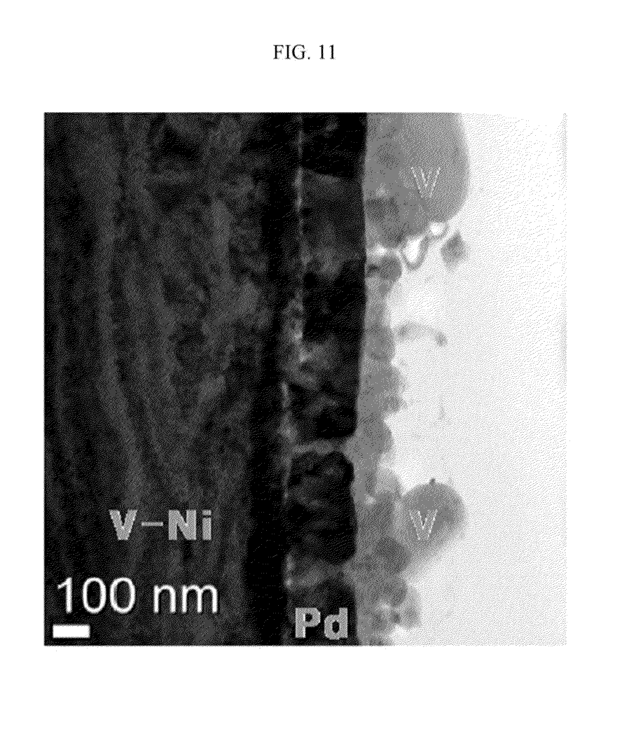

FIG. 10 illustrates a transmission electron microphotograph of a section of a membrane surface of Experimental Example 6, and FIG. 11 illustrates a transmission electron microphotograph of a section of a membrane surface of

Comparative Example 2.

At the left side of FIG. 10, a membrane that is formed with a vanadium alloy V—Ni—Y was formed, and at the right side thereof, a palladium catalyst layer having a thickness of about 200 nm was formed. As shown in FIG. 10, in the membrane of Experimental Example 6, it was determined that a surface of a palladium catalyst layer was very cleanly formed.

In contrast, in the membrane of Comparative Example 2 of FIG. 11, at the left side thereof, a membrane that is formed with a vanadium alloy V—Ni was formed, and at the center thereof, a palladium catalyst layer with a thickness of about 200 nm was formed. At the right side of FIG. 11, it was observed that a specific material covers a surface of the palladium catalyst layer. By measuring a composition of the specific material by energy spectroscopic analysis (EDS), it was determined that the material that covers a surface of the palladium catalyst layer is vanadium.

The phenomenon in which vanadium comes out of the surface through the palladium catalyst layer will be described. In Comparative Example 2, atoms of vanadium and nickel under a palladium catalyst layer are diffused to the outside through a grain boundary of palladium at a high temperature of 400° C. or more. While palladium diffuses into a base metal of a membrane that is formed with vanadium, mutual diffusion occurs. As the mutual diffusion occurs, when vanadium completely covers a surface of the membrane, the catalyst performance of the membrane surface is remarkably deteriorated, compared with the catalyst performance of palladium. Therefore, hydrogen permeability performance of the membrane is greatly deteriorated. Thus, when maximally suppressing mutual diffusion, the structure of a membrane in which the palladium catalyst layer is coated may be stabilized for a long term.

In Experimental Example 6, by adding yttrium at an infinitesimal quantity, the mutual diffusion phenomenon between vanadium and palladium was reduced. Therefore, by using yttrium in an alloy for a membrane, durability of the membrane can be enhanced.

### Effect Experiment of Membrane Formed with Vanadium-based Alloy according to Addition of Yttrium and Iron

Experimental Example 7

A membrane that is formed with a hydrogen permeation alloy of a V_{84.8}Ni₅Fe₁₀Y_{0.2} composition, which is a quaternary system, was produced. In order to produce a membrane, by mutually mixing nickel (Ni), iron (Fe), yttrium (Y), and vanadium (V), a mixture was produced. By vacuum melting the mixture, an alloy was produced, and by cutting the alloy, a membrane was produced.

Experiment Results

Hydrogen Permeability Experiment

A transmission performance and long term structure stability of the membrane of Experimental Example 7 were tested. First, a hydrogen permeability experiment was performed for 11 days at a temperature of 300° C. using the membrane of Experimental Example 7.

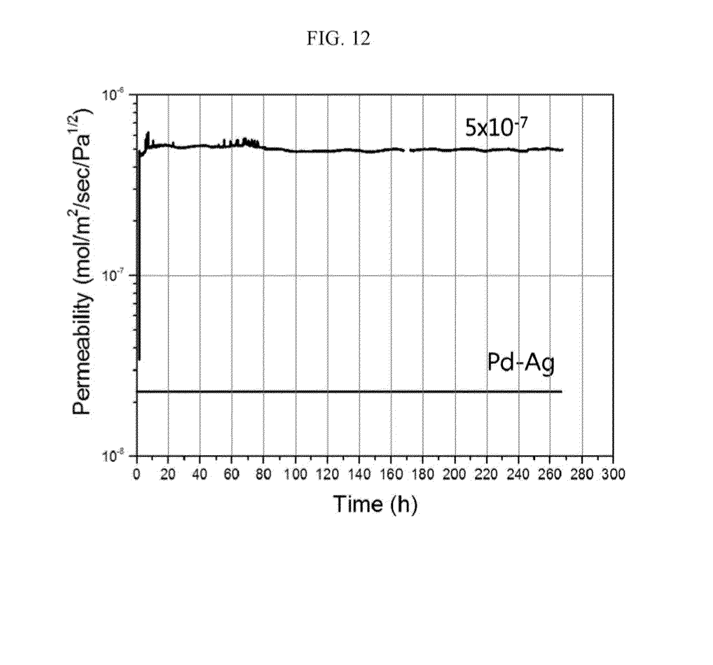

FIG. 12 illustrates a hydrogen permeability experiment result of a hydrogen permeation alloy of Experimental Example 7 of the present invention.

As shown in FIG. 12, the hydrogen permeation alloy of Experimental Example 7 maintained high hydrogen permeability during about 11 days, and while permeating hydrogen, the membrane was not broken. Therefore, it can be seen that a hydrogen permeation alloy that is used for the membrane has high structural stability and mechanical characteristics. For comparison, FIG. 12 also illustrates hydrogen permeability of a well-known Pd—Ag alloy.

On-Off Type Hydrogen Permeability Experiment

Operation and non-operation of a membrane that is formed with a hydrogen permeation alloy of Experimental Example 7 were repeated. That is, as in the foregoing long-term hydrogen permeability experiment, hydrogen permeability was not maintained in a predetermined condition, and for the membrane, on-off cycling of about 30 times was performed. Here, the hydrogen permeation temperature was 400° C., and the hydrogen pressure of the hydrogen injection opening side was 3 bar. Thereby, it was determined whether embrittlement according to repetition of a process in which the membrane is operated and cooled occurred.

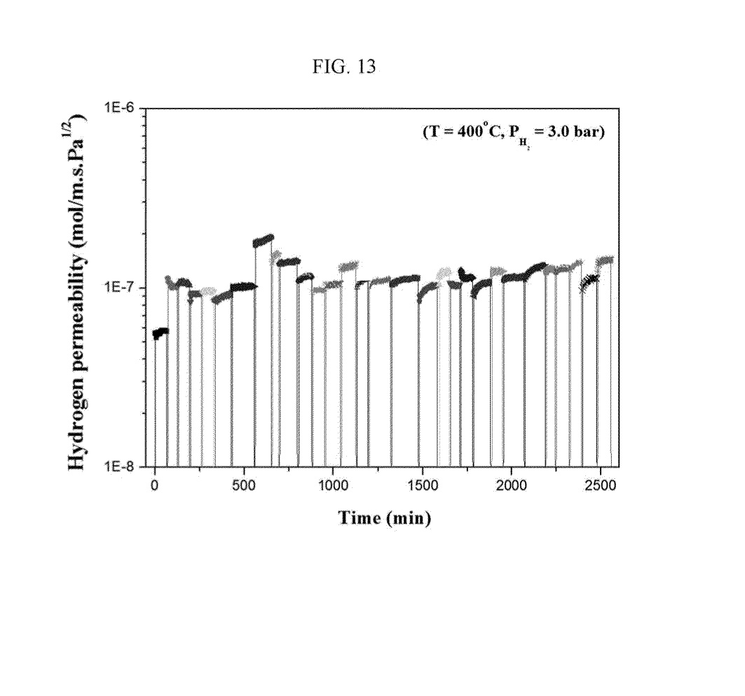

FIG. 13 illustrates an on-off type hydrogen permeability experiment result of a hydrogen permeation alloy of Experimental Example 7 of the present invention. It can be seen from FIG. 13 that the membrane can well overcome the embrittlement fracture that is likely to occur while cooling after operation.

In Experimental Example 7, by using iron and nickel together, resistance to hydrogen embrittlement of a vanadium-based alloy was improved. Therefore, by only reducing solubility of hydrogen while maintaining a diffusion coefficient of hydrogen similar to a membrane that is formed with pure vanadium, a flux of hydrogen that passes through the membrane is not greatly reduced. Further, the structure of the membrane can be prevented from being weakened due to hydrogen.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vanadium-based hydrogen permeation alloy for a membrane comprising nickel (Ni) at more than 0 atm % and 5 atm % or less, iron (Fe) at 5 atm % to 15 atm %, yttrium (Y) at more than 0 and 1 atm % or less, and a remainder of vanadium and impurities.

2. The vanadium-based hydrogen permeation alloy of claim 1, wherein a quantity of the nickel (Ni) is 3 atm % to 5 atm %, a quantity of the iron (Fe) is 8 atm % to 15 atm %, and a quantity of the yttrium (Y) is more than 0 atm % and 0.2 atm % or less.

3. The vanadium-based hydrogen permeation alloy of claim 2, wherein a quantity of the iron (Fe) is 8 atm % to 12 atm %, and a quantity of the yttrium (Y) is 0.1 atm % to 0.2 atm %.

4. A method of manufacturing a vanadium-based hydrogen permeation alloy for a membrane, the method comprising:
providing a mixture by mutually mixing nickel, iron, yttrium, and a remainder of vanadium and impurities;
providing an alloy by melting the mixture; and
providing a thin film by cutting or rolling the alloy, wherein in the providing of a mixture, a quantity of the nickel (Ni) is more than 0 atm % and 5 atm % or less, a quantity of the iron (Fe) is 5 atm % to 15 atm %, and a quantity of the yttrium (Y) is more than 0 atm % and 1 atm % or less.

5. A method of using a membrane, comprising:
providing a membrane comprising a vanadium-based hydrogen permeation alloy comprising nickel (Ni) at more than 0 and 5 atm % or less, iron (Fe) at 5 atm % to 15 atm %, yttrium (Y) at more than 0 atm % and 1 atm % or less, and a remainder of vanadium and impurities; and
permeating hydrogen by operating the membrane at a temperature of 250° C. to 500° C.
